(19) United States
(12) Patent Application Publication
(10) Pub. No.: US 2009/0095774 A1
(43) Pub. Date: Apr. 16, 2009

(54) APPLIANCE FOR DISPENSING HEATED COSMETIC FLUIDS

(75) Inventor: Brett Christopher Domoy, Brookfield, CT (US)

Correspondence Address: UNILEVER PATENT GROUP, 800 SYLVAN AVENUE, AG West S. Wing, ENGLEWOOD CLIFFS, NJ, 07632-3100, US

(73) Assignee: CONOPCO, INC., D/B/A UNILEVER, Englewood Cliffs, NJ (US)

(21) Appl. No.: 11/870,432

(22) Filed: Oct. 11, 2007

(51) Int. Cl. B67D 5/62; B67D 5/06; B65D 37/00; B65D 35/38

(52) U.S. Cl. 222/146.5; 222/212; 222/494; 222/185.1

(57) ABSTRACT

A device is provided for delivering a heated cosmetic flowable product. The device includes a base with a cavity housing a tube for receiving the flowable product, a heating system heatingly contacting the tube, and an outlet at a downstream end of the tube. A plastic bottle filled with the product is releasably mounted on the base. A fitment is arranged over an open end of the bottle and includes a slitted membrane. An upstream end of the tube penetrates the membrane to establish flowable communication and a sealing relationship. Product is dispensed from the outlet by applying an external squeeze pressure against a wall of the bottle. No mechanical assist is necessary such as a pump or gearing for transporting fluid product.

### BACKGROUND OF THE INVENTION

1. Field of the Invention

The invention concerns an appliance for heating a flowable cosmetic composition, particularly a non-foaming skin cream or lotion, for application to the human body.

2. The Related Art

Cold lotion applied to the skin often is not a pleasant experience. Warmed lotions provide a contrasting experience. Heat soothes. Aching muscles respond well to warmth. While cold constricts, warmth tends to open pores. The lotions can thereby penetrate deeper with positive results. The sensual experience may also be heightened at elevated temperatures.

Appliances to deliver heated shaving creams are well documented in the literature. Illustrative is U.S. Pat. No. 6,056,160 (Carlucci et al.) reporting a heating mechanism applied over the nozzle of a pressurized shaving cream can. Foaming liquid is forced through the interstices of a heat exchange coil to achieve rapid temperature increase. A drawback of this system is the need for pressurized gas. Without pressurization there is no expelling force to drive shaving cream through the coiled heater.

Another approach is found in U.S. Pat. No. 6,216,911 B1 (Kreitemier et al.). Instead of a disposable pressurized shaving cream can, this disclosure utilizes an integrally formed main fluid reservoir as a storage source for lotion or other dispensable fluids. Transport of the fluid to a secondary heating chamber requires a pump assembly with attendant gears and motors. This system suffers from several disadvantages. Pumps and their attendant gears/motors are subject to break down. Further, clean out of the fluid reservoir is required when changing to a different dispensed product. There may be considerable wastage when a changeover occurs with the main fluid reservoir and secondary heating chamber still storing a significant charge of the initial fluid.

Accordingly, the present invention is directed at resolving some of the prior art problems. In particular, an appliance for heating cosmetic fluids is sought which utilizes less expensive and uncomplicated fluid transport mechanisms, particularly a system without an electrified pump mechanism (which may have a motor and/or gears).

Yet another desirable advance would be an appliance wherein the main reservoir and heating chamber would not present a cleaning and a fluid wastage problem. Especially desirable would be a system in which differently formulated cosmetic fluids could easily replace one another as feed in the appliance.

### SUMMARY OF THE INVENTION

A device for delivery of heated cosmetic flowable composition is provided which includes:
(i) a base with a cavity housing a tube for receiving flowable composition, a heating system heatingly contacting the tube, and an outlet at a downstream end of the tube; and
(ii) a plastic bottle releasably mounted on the base filled with the flowable composition having a closed and an open end, the open end engaged by a fitment having a membrane stretched over a mouth of the bottle, the membrane being penetrateable by an upstream end of the tube or a communicating projection thereof to allow leakage free flow of the composition from the bottle to the tube, dispensing of the flowable composition from the outlet being urged by manual squeeze pressure applied against a wall of the bottle.

### DETAILED DESCRIPTION OF THE DRAWINGS

Further advantages and features of the present invention will become more readily apparent from consideration of the drawing in which:

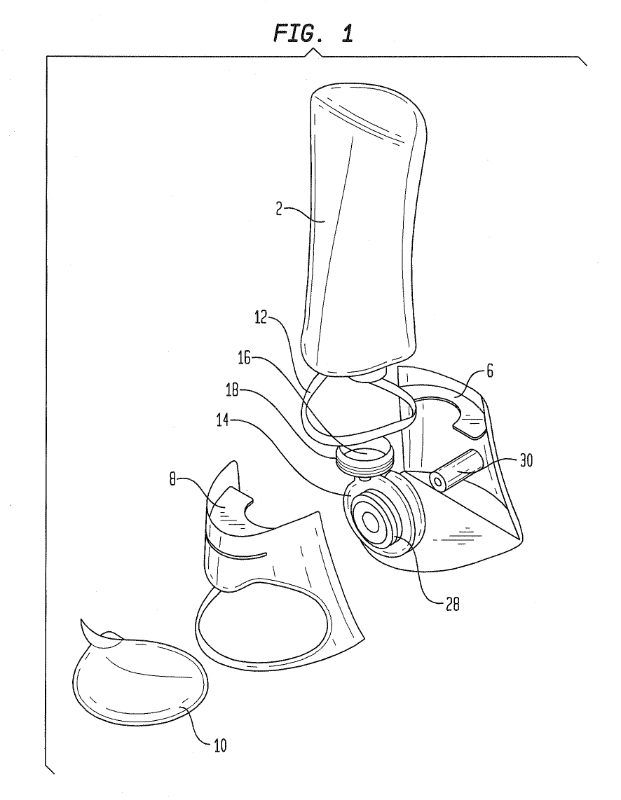

FIG. 1 is an exploded view of the device;

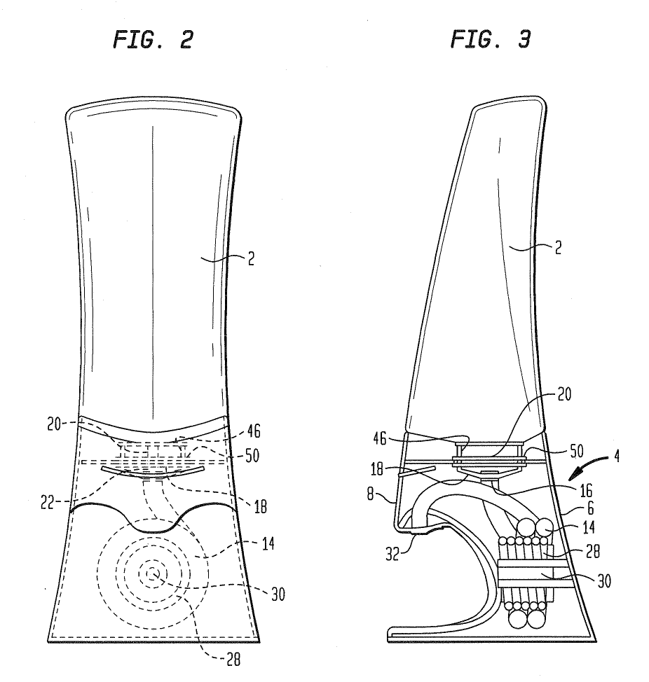

FIG. 2 is a front elevational view of the device;

FIG. 3 is a side elevational view with the base in cross-sectional exposure;

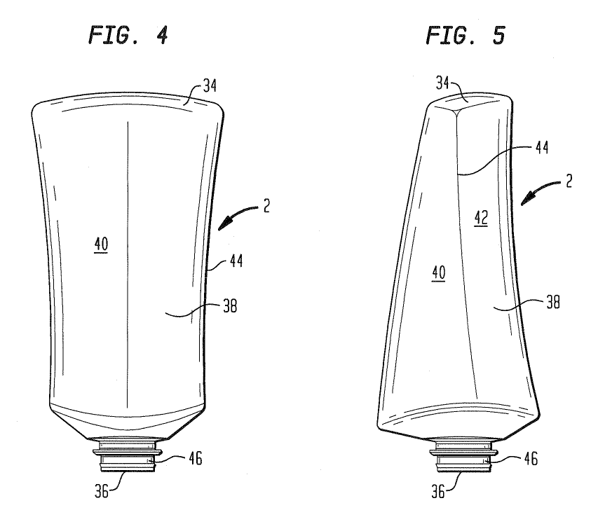

FIG. 4 is a front elevational view of a bottle for use as a cosmetic composition main reservoir;

FIG. 5 is a side elevational view of the bottle as shown in FIG. 4;

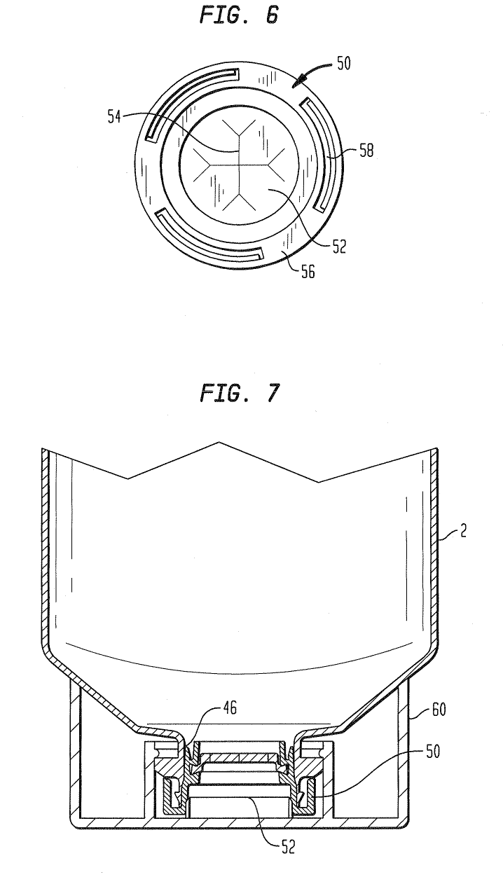

FIG. 6 is a top plan view of a fitment with membrane inserted in an open mouth of the bottle; and

FIG. 7 is a partial cross-sectional view of a lower area of the bottle featuring a service cap for use only in shipment.

### DETAILED DESCRIPTION OF THE INVENTION

Now it has been found that a flexible walled easily replaceable plastic bottle situated above an outlet for exiting cosmetic product has dual function to resolve problems of the prior art. First the bottle serves as the main reservoir for delivering cosmetic product to a heated section of the appliance. Secondly, the bottle can serve as a refill or alternative composition replacement unit for the original bottle. There is no need for messy clean out. Product wastage is minimized. Alternative cosmetic composition formulas can quickly replace the original.

Of particular distinction over earlier motorized pump applicances, the present system allows ready evacuation of product retained in the secondary heating chamber. Manual pressure on the bottle wall forces air throughout the delivery system. Only by this manual method can complete evacuation be accomplished.

FIG. 1 illustrates one embodiment of the invention as an exploded view of the device. Sections of the device include a bottle 2 and a base 4, the latter including a back clamshell 6, a front clamshell 8 and a nozzle/cup moulding 10. A collar 12 secures the front to the back clamshell.

A coiled tube 14 constructed of aluminum to achieve rapid heat-up is supported within the back clamshell. The shown embodiment uses two coil cycles (360° twist). More cycles (twists) may be utilized, particularly between two and six cycles.

A first end 16 of the coiled tube leads into a receiving cup 18. A projection tube 20 extends upwards from the cup 18 and is in flow communication with end 16 of the coiled tube. A pressure equalization valve 22 in form of a check-ball is arranged between first end 16 and the projection tube 20. This valve is in sealable communication with coiled tube 14 and an internal cavity 38 of the bottle.

A coiled heater 28 is concentrically arranged within the coils of the tube 16. A cylindrical support 30 projects from a wall of the back clamshell and provides support to both the heater and coiled tube. An outlet 32 is arranged at a downstream end of the tube, best illustrated in FIG. 3.

FIGS. 4 and 5 illustrate the plastic bottle 2 utilized as a reservoir for delivering cosmetic flowable product into the heating device. The bottle has a closed end 34 and an open mouth 36. Cavity 38 within the plastic bottle stores the cosmetic flowable product.

Featured on the bottle is a front major panel 40 and a rear major panel 42, each separated by lateral seams 44 asymmetrically separating front and rear major panels. The seams traverse the bottle from the closed end to a shoulder near the neck in a non-linear curved manner. In a preferred embodiment, areas on the front panel are shaped to have a more rigid wall than areas on the rear panel. This allows for squeezability to force cosmetic flowable product downward into the coiled tube. Differences in squeezability between front and rear panels can be achieved in at least two ways. The first is through differences in thickness in the extruded walls of the plastic bottle. Secondly, flexibility differences can simply be obtained through a differential radial shape.

Plastic bottle 2 has a neck 46 leading to the open mouth 36. A fitment 50 is secured over the neck and features an elastic membrane 52. Suitable materials of construction for the membrane are elastomers, particularly a silicone elastomer. A plurality of slits 54 are cut near a center area of the membrane to facilitate a forced coupling. The multi-slitted flexible membrane is best illustrated in FIG. 6.

Fitment 50 includes a circumferentially outwardly projecting ridge 56 featuring three equidistant semi-circular elongated apertures 58. These apertures lockingly connect with the neck of the bottle.

Plastic bottle 2 is easily joined to the base 4 by placement of fitment 50 directly over cup 18. The projection tube 20 and membrane 52 are aligned. Downward pressure assisted by a twisting motion forces projection tube 20 to part slits of the membrane and penetrate into the bottle cavity.

A user activates dispensing by wrapping one hand around the bottle and applying squeeze pressure thereto. Squeezing restricts the bottle internal volume forcing the cosmetic composition to flow downward into the coiled tube. In a fully charged system, the squeeze pressure forces a proportionate amount of cosmetic composition to be dispensed from the outlet (at the end of the coiled tube). Any vacuum created in the plastic bottle by the dispensing operation is countered by atmospheric air entering the pressure equalization valve.

Flowable cosmetic composition held within the coiled tube is warmed by the heater upon activation of a on/off switch formed in the base. Electric power is obtained through a plug-in cord drawing energy from a standard AC outlet. Although not illustrated, battery power may be an alternative energy source. The heating system consists of a rheostat and conductive wires which are coiled around the coiled tube. Temperatures imparted to the flowable composition may range from about 40° to about 60° C., preferably from about 44° to about 54° C., and optimally about 48° C.

FIG. 7 illustrates in cross-sectional and partial view a lower area of the plastic bottle as a refill. The lower end of the bottle is covered by a service cap 60. This cap permits shipment and avoidance of dust from entering through the membrane and neck.

What is claimed is:

1. A device for delivering a heated cosmetic flowable cosmetic product comprising:
(i) a base with a cavity housing a tube for receiving flowable composition, a heating system heatingly contacting the tube, and an outlet at a downstream end of the tube; and
(ii) a plastic bottle releasably mounted on the base filled with the flowable composition having a closed and an open end, the open end engaged by a fitment having a membrane stretched over a mouth of the bottle, the membrane being penetrateable by an upstream end of the tube or a communicating projection thereof to allow leakage free flow of the composition from the bottle to the tube, dispensing of the flowable composition from the outlet being urged by manual squeeze pressure applied against a wall of the bottle.

2. The device according to claim 1 wherein the tube is coiled.

3. The device according to claim 2 wherein the tube is coiled and has from two to six coil cycles.

4. The device according to claim 1 wherein the heating system comprises a coiled heating strip.

5. The device according to claim 1 wherein the bottle has a front and rear panel separated by a non-linear seam traversing a majority of a length of the bottle.

6. The device according to claim 1 wherein the fitment comprises a slitted membrane.

7. The device according to claim 6 wherein the slitted membrane is formed of a silicone material.

8. The device according to claim 1 devoid of any electrically operated pump system.

9. The device according to claim 1 devoid of gears for movement of cosmetic flowable product.

10. The device according to claim 1 wherein the outlet for cosmetic flowable product is arranged totally below the plastic bottle.
